(19) United States
(12) Patent Application Publication
(10) Pub. No.: US 2016/0161522 A1
(43) Pub. Date: Jun. 9, 2016

(54) A SENSOR-BEARING UNIT, A MECHANICAL SYSTEM COMPRISING AT LEAST ONE SUCH UNIT AND IMPLEMENTING METHODS

(71) Applicant: AKTIEBOLAGET SKF, Göteborg (SE)

(72) Inventors: Olivier CHEVE, Chanceaux S/Choisille (FR); Mathieu HUBERT, Tours (FR); Benoît LOCHER, Tours (FR)

(73) Assignee: Aktiebolaget SKF, Göteborg (SE)

(21) Appl. No.: 14/905,986

(22) PCT Filed: Jul. 24, 2013
(86) PCT No.: PCT/EP2013/065652

§ 371 Date: Jan. 19, 2016

(51) Int. Cl. G01P 3/44; G01D 5/245

(52) U.S. Cl. CPC G01P 3/443; G01D 5/2451

(57) ABSTRACT

A sensor-bearing unit, comprising: a bearing including at least one non-rotating ring and at least one rotating ring movable in rotation around a rotation axis; an impulse ring and a sensor device for tracking the rotation of the rotating ring around the rotation axis. The impulse ring is fixed to the rotating ring. The sensor device is fixed to the non-rotating ring and includes a differential detection cell having a structural pitch. The differential detection cell is tilted and has an effective pitch different from the structural pitch. A mechanical system can such sensor-bearing unit.

### CROSS REFERENCE TO RELATED APPLICATION

This is a United States National Stage Application claiming the benefit of International Application Number PCT/EP2013/065652 filed on 24 Jul. 2013 (24.07.2013), which is incorporated herein by reference in its entirety.

### TECHNICAL FIELD OF THE INVENTION

The invention concerns a sensor-bearing unit. The invention also concerns a mechanical system, for example a motorcycle axle, comprising at least one such sensor-bearing unit. The invention also concerns different methods for implementing such sensor-bearing unit.

### BACKGROUND OF THE INVENTION

Today, sensor-bearing units are commonly used in automotive, aeronautics and other technical fields. These units provide high quality signals and transmissions, while allowing integration in simpler and more compact mechanical systems.

Such a sensor-bearing unit generally comprises a bearing, an impulse ring and a sensor device facing the impulse ring. The impulse ring may be fixed to a rotating ring of the bearing, while sensor device may be fixed to a non-rotating ring of the bearing or to another part supporting this non-rotating ring. The impulse ring may comprise a target holder and a target including alternating north and south poles, whose number depends on bearing size and particular application. The sensor device may comprise a differential hall cell including two sensing elements.

For certain applications, by example wheel speed measurement, a differential sensor device allows to reduce noise and increase amplitude of the electric signal inside the sensor device by a subtraction of the two measurements. To obtain the maximum efficiency of this effect, the pitch between the two sensitive elements and the pitch of the magnetic ring should be compatible, i.e. be equal for this application. Otherwise, the designer of the sensor-bearing unit may change the hall cell for a more compatible one or modify the size of the impulse ring.

For other applications, by example incremental encoders, a differential sensor device is used to create two signals with a phase shift of 90 degrees. The pitch between the two sensitive elements cannot be changed without a new sensor design, otherwise the phase shift between the two signals would not be equal to 90 degrees. The sensor designer has no flexibility concerning pitch of the impulse ring, which has to be designed in parallel to hall cell.

### SUMMARY OF THE INVENTION

The aim of the invention is to provide a sensor-bearing unit with improved flexibility.

To this end, the invention concerns a sensor-bearing unit, comprising:
a bearing including at least one non-rotating ring and at least one rotating ring movable in rotation around a rotation axis;
an impulse ring and a sensor device for tracking the rotation of the rotating ring around the rotation axis, the impulse ring being fixed to the rotating ring, the sensor device being fixed to the non-rotating ring and including a differential detection cell having a structural pitch,
wherein the differential detection cell is tilted and has an effective pitch different from the structural pitch.

Thanks to the invention, the pitch of the detection cell is more flexible. Consequently, design of the impulse ring is more flexible too. If the impulse ring is fixed and cannot be changed, structural pitch of the detection cell can be chosen without mandatory compatibility with pitch of the impulse ring. If the impulse ring is changed, structural pitch of the detection cell can adjusted by tilting. The invention may be implemented within speed sensors, crankshaft and camshaft sensors, incremental encoders, etc.

According to further aspects of the invention which are advantageous but not compulsory, such a sensor-bearing unit may incorporate one or several of the following features:
The effective pitch of the differential detection cell is equal to a structural pitch of the impulse ring.
The differential detection cell is tilted of an angle of 45 degrees.
The sensor-bearing unit includes means for tilting the differential detection cell with respect to the impulse ring.
The tilting means are linked to a controller.
The tilting means are located inside a body of the sensor device.
The tilting means are located inside an anti-rotating cable output of the sensor device.
The sensor-bearing unit includes an anti-rotating cable output guiding a cable from the differential detection cell to outside a sensor body and comprising anti-rotating means for preventing rotation of the sensor body and the cable around the rotation axis by cooperation with a support part fixed with respect with the rotation axis.

The invention also concerns a mechanical system, for example a motorcycle axle, comprising at least one sensor-bearing unit as mentioned here-above.

The invention also concerns methods for implementing a sensor-bearing unit as mentioned here-above.

According to a first embodiment, the method comprises at least a step of tilting the differential detection cell with respect to the impulse ring.

According to a second embodiment, the method comprises at least a step of replacing an existing detection cell with the differential detection cell tilted with respect to the impulse ring.

### BRIEF DESCRIPTION OF THE DRAWINGS

The invention will now be explained in correspondence with the annexed figures, and as an illustrative example, without restricting the object of the invention. In the annexed figures:

FIG. 1 is a partial perspective view of a mechanical system according to the invention, of the motorcycle axle type, comprising a fork, a hub and a sensor-bearing unit also according to the invention;

FIG. 2 is a perspective view similar to FIG. 1, at a larger scale, showing a bearing, an impulse ring and a detection cell belonging to the sensor-bearing unit;

FIG. 3 is a side view along arrow III of FIG. 2;

FIG. 4 is a partial side view, at a larger scale, along arrow IV of FIG. 3;

FIG. 5 is a view at a larger scale of detail V from FIG. 3; and

FIGS. 6, 7 and 8 are schematic views of detection cell and impulse ring, illustrating the principle of the invention.

### DETAILED DESCRIPTION OF SOME EMBODIMENTS

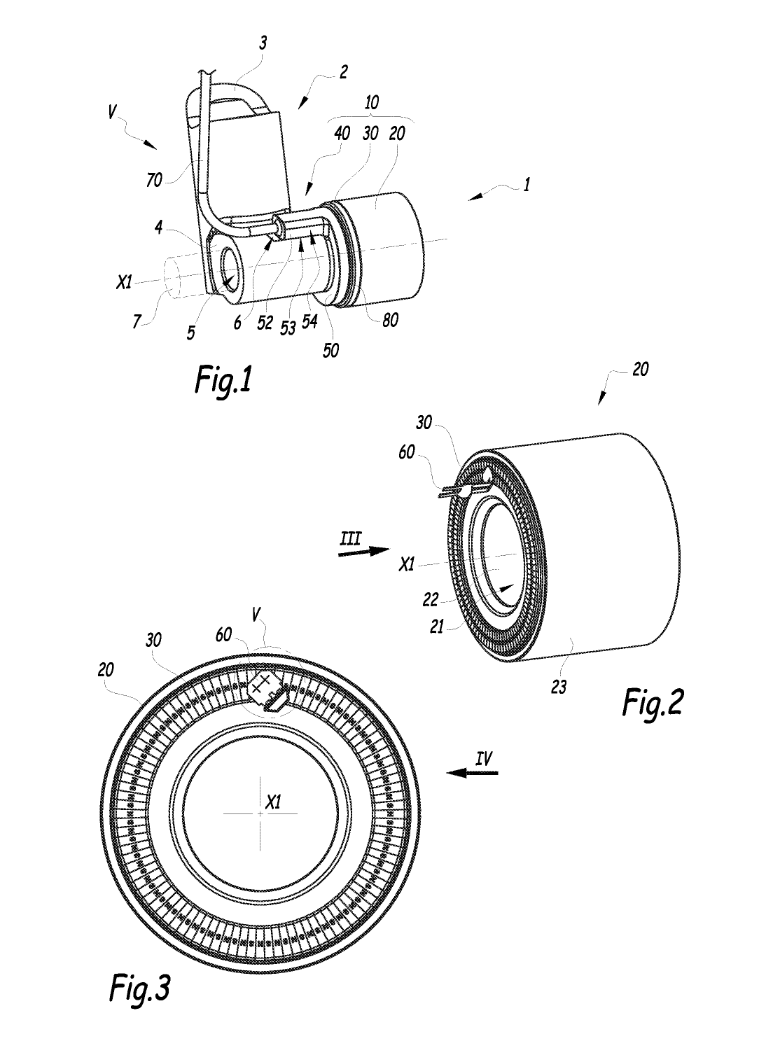

FIG. 1 shows a motorcycle axle 1 according to the invention.

Axle 1 equips a vehicle V according to the invention, of the motorcycle type, partially shown on FIG. 1. Axle 1 is equipped with a sensor-bearing unit 10 according to the invention, shown on FIGS. 1 to 5.

Axle 1 comprises a fork 2 having a vertical part 3 and a horizontal part 4 delimiting an inner housing 5. A groove 6 is formed part 4 for receiving unit 10. Axle 1 also comprises a shaft 7, schematically represented by dotted lines on FIG. 1 for simplification purpose, extending along a central axis X1 of axle 1. Shaft 7 is fitted in housing 5 of fork 2 and in an inner housing 21 of a bearing 20. Shaft 7 is fixed to part 4 of fork 2 and to an inner ring 22 of bearing 20 by fixation means not shown. Axle 1 also comprises a hub not shown, mounted on an outer ring 23 of bearing 20 and adapted to receive a wheel. Shaft 7 and inner ring 22 are not movable in rotation around axis X1, while hub and outer ring 23 are movable in rotation around axis X1.

Instead of axle 1, unit 10 may equip any suitable mechanical system, preferably belonging to a vehicle V such as a motorcycle, an automotive or a truck.

Sensor-bearing unit 10 comprises a bearing 20, an impulse ring 30 and a sensor device 40. Impulse ring 30 comprises a target assembly 31 and a seal assembly 32. Sensor device 40 comprises a sensor body 50, a differential detection cell or hall cell 60, a cable 70 and a spacer 80.

Bearing 20 comprises rolling elements not shown, located between inner ring 22 and outer ring 23. Inner ring 22 is mounted on shaft 7 and fixed relative to fork 2, shaft 7 and around axis X1. Outer ring 23 is fitted inside the hub not shown and movable in rotation around axis X1.

Impulse ring 30, more precisely target 33, has a structural pitch Sp30 defined along a line L30. Impulse ring 30 is fixed to outer ring 23, while sensor device 40 is fixed to inner ring 22. Impulse ring 30 extends radially to rotation axis X1 not beyond outer ring 23. Impulse ring 30 comprises only two assemblies 31 and 32 and only four parts 33, 34, 35 and 36, allowing easy manufacturing and assembly. Impulse ring 30 has a structural pitch Sp30 which is a known and fixed distance measured along a line L30.

Target assembly 31 comprises a magnetic target 33 and a target holder 34. Target 33 extends substantially radially to axis X1. Target 33 comprises a face oriented toward sensor device 60 and a face fixed to holder 34. Holder 34 comprises a tubular axial portion for outer fixation to outer ring 23 and for inner fixation of seal assembly 32. Holder 34 also comprises an annular radial portion having a face receiving target 33 and a face oriented toward seal assembly 32. Holder 34 is preferably made of metal or plastic. Target 33 and holder 34 may be connected by bonding, vulcanization or by any suitable means.

Seal assembly 32 comprises a radial seal 35 and a seal holder 36. Seal 35 comprises a base fixed to seal holder 36 and a sealing lip which is substantially radial and adapted to be positioned in dynamic sealing contact with inner ring 22. In other words, seal 35 is a radial seal. Seal 35 is advantageously made of elastically deformable material, for example elastomer or thermoplastic. Holder 36 comprises a tubular axial portion for outer fixation to holder 34. Holder 36 also comprises an annular radial portion having a face oriented toward target assembly 31 and a face oriented inside bearing 20. Holder 36 is preferably made of metal or plastic. Seal 35 and holder 36 may be connected by molding of seal 35 on holder 36, by bonding, vulcanization or by any suitable means.

Alternatively, seal assembly 32 may comprise only seal 35 but not seal holder 36. Seal 35 is fixed to target holder 34. Impulse ring 30 comprises only three parts.

Sensor body 50 is made of plastic or metal. Body 50 comprises a cable output 52 extending parallel to axis X1 opposite bearing 20. Cable 70 extends from cell 60 to the outside of body 50 through cable output 52. In other words, cable output 52 guides cable 70 from cell 60 to the outside of body 50. Cable output 52 comprises a plane bottom surface 53 perpendicular to plane P1 and two plane lateral surfaces 54 parallel to plane P1. When cable output 52 is fitted into groove 6 of fork 2, lateral surfaces 54 come in resting contact with borders of groove 6, while bottom surface 53 faces bottom surface of groove 6. Since body 50 is elastically deformable, surface 53 may come at least partly in resting contact with bottom of groove 6 when cable output 52 is subjected to a torsional torque which is above a particular torque value.

In practice, surfaces 53 and 54 of cable output 52 form anti-rotating means of body 50 around axis X1 relative to support fork 2. In other words, the anti-rotating means 53 and 54 are adapted for preventing rotation of body 50 and cable 70 around axis X1 when cooperating with support fork 2. Preferably, cable output 52 may be force-fitted into groove 6. Anti-rotating cable output 52 provides both the functions of guiding cable 70 and of preventing rotation of body 50 and cable 70 around axis X1, consequently protecting sensor device 40.

Cell 60 is housed inside body 50 and positioned as close as possible to magnetic target 33. Cell 60 comprises two sensitive elements 61 and 62, schematically represented by their respective centers on FIG. 5, each detecting magnetic field variations induced by magnetic target 33. The accuracy of rotation speed, rotation angle and other data measured by the sensor-bearing unit 10 are highly related to the accuracy of the mounting of the detection cell 60 and the magnetic target 33.

Elements 61 and 62 define a structural pitch Sp60 of cell 60. Pitch Sp60 is a known and fixed distance measured along a line L60 between the two centers of elements 61 and 62.

A plane P1 is defined, including axis X1 and equidistant between elements 61 and 62. Three circles C1, C2 and C3 are defined around axis X1, with respective radius R1, R2 and R3. Center of element 61 is located on circle C1, center of element 62 is located on circle C2, while circle C3 is equidistant to circles C1 and C2. In other words, radius R3 is equal to the average of radiuses R1 and R2. Line L30 extends tangentially to circle C2 and perpendicular to plane P1. Pitch Sp30 matches the pole size of target 33 along line L30.

According to the invention, cell 60 is tilted and elements 61 and 62 define an effective pitch Hp60 different from structural pitch Sp60. Contrary to usual sensor-bearing units in which lines L30 and L60 are parallel or aligned, within unit 10 the lines L30 and L60 form an angle β. In the example of FIG. 5, angle β is equal to 45 degrees and pitch Hp60 is equal to pitch Sp30.

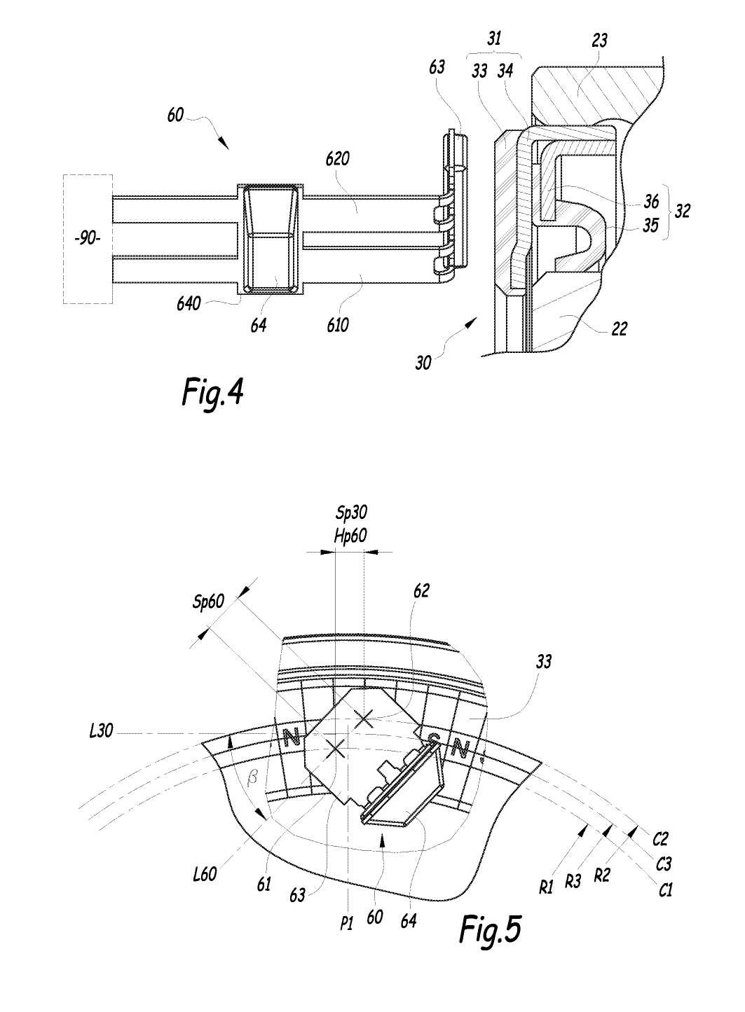

Unit 10 may also include a device 90, schematically represented by a block in dashed lines on FIG. 4, for tilting the differential detection cell 60 with respect to the impulse ring 30. In other words, tilting device 90 allows to modify angle β and pitch Hp60. Tilting device 90 may be linked to a controller, in particular via cable 70. Tilting means 90 may be located outside or inside body 50, by example inside cable output 52.

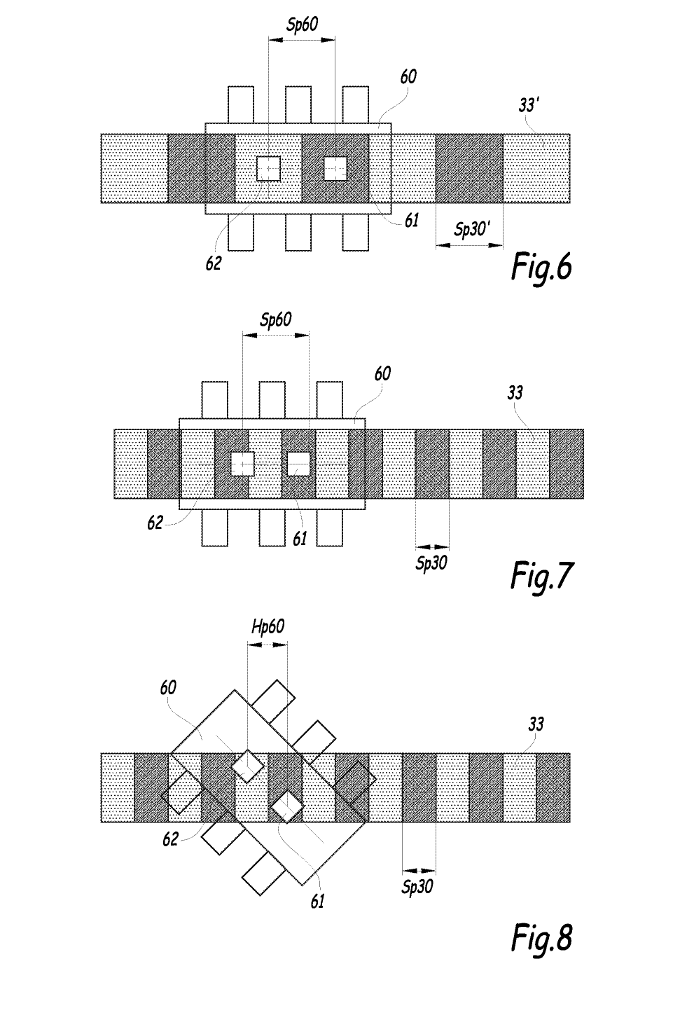

FIGS. 6 to 8 illustrate principle of the invention. FIG. 6 shows pitch Sp60 matching a pitch Sp30′ of a target 33′. FIG. 7 shows that when target 33′ is replaced by target 33, pitch Sp60 no longer matches pitch Sp30. FIG. 8 shows that by tilting cell 60, pitch Hp60 is adjusted to match pitch Sp30.

A method for implementing unit 10 according to the invention may comprise a step of replacing an existing detection cell with the differential detection cell 60 tilted with respect to impulse ring 30. Another method may comprise a step of tilting the existing differential detection cell 60 with respect to impulse ring 30.

Other non-shown embodiments of vehicle V, mechanical system 1 and/or sensor-bearing unit 10 can be implemented without leaving the scope of the invention. For example, constitutive parts of the impulse ring 30 and/or of the sensor device 40 may be different from FIGS. 1 to 8.

Whatever the embodiment, the differential detection cell 60 is tilted with respect to the impulse ring 30 and has an effective pitch Hp60 different from its structural pitch Sp60. Preferably, effective pitch Hp60 of the differential detection cell 60 is equal to a structural pitch Sp30 of the impulse ring 30, as shown on FIG. 5.

In addition, technical features of the different embodiments can be, in whole or part, combined with each other. Thus, mechanical system 1 and/or sensor-bearing unit 10 can be adapted in terms of cost or to any specific requirements of the application.

1. A sensor-bearing unit, comprising:
a bearing including at least one non-rotating ring and at least one rotating ring movable in rotation around a rotation axis; and
an impulse ring and a sensor device for tracking the rotation of the rotating ring around the rotation axis, the impulse ring being fixed to the rotating ring, the sensor device being fixed to the non-rotating ring and including a differential detection cell having a structural pitch,
wherein the differential detection cell is tilted and has an effective pitch different from the structural pitch.

2. The sensor-bearing unit according to claim 1, wherein the effective pitch of the differential detection cell is equal to a structural pitch of the impulse ring.

3. The sensor-bearing unit according to claim 1, wherein the differential detection cell is tilted of at angle of 45 degrees.

4. The sensor-bearing unit according to claim 1, further comprising a tilting mechanism for tilting the differential detection cell with respect to the impulse ring.

5. The sensor-bearing unit according to claim 4, wherein the tilting mechanism is linked to a controller.

6. The sensor-bearing unit according to claim 4, wherein the tilting mechanism is located inside a body of the sensor device.

7. The sensor-bearing unit according to claim 6, wherein the tilting mechanism is located inside an anti-rotating cable output of the sensor device.

8. The sensor-bearing unit according to claim 1, further comprising an anti-rotating cable output guiding a cable from the differential detection cell to outside a sensor body and comprising anti-rotating feature for preventing rotation of the sensor body and the cable around the rotation axis by cooperation with a support part fixed with respect with the rotation axis.

9. The sensor-bearing according to claim 1, wherein the sensor-bearing is installed into a mechanical system.

10. A method for implementing a sensor-bearing unit the sensor-bearing unit comprising:
a bearing including at least one non-rotating ring and at least one rotating ring movable in rotation around a rotation axis, and
an impulse ring and a sensor device for tracking the rotation of the rotating ring around the rotation axis, the impulse ring being fixed to the rotating ring, the sensor device being fixed to the non-rotating ring and including a differential detection cell having a structural pitch,
wherein the differential detection cell has an effective pitch different from the structural pitch,
the method comprising a step of:
tilting the differential detection cell with respect to the impulse ring.

11. A method for implementing a sensor-bearing unit the sensor-bearing unit comprising:
a bearing including at least one non-rotating ring and at least one rotating ring movable in rotation around a rotation axis; and
an impulse ring and a sensor device for tracking the rotation of the rotating ring around the rotation axis, the impulse ring being fixed to the rotating ring, the sensor device being fixed to the non-rotating ring and including a differential detection cell having a structural pitch,
wherein the differential detection cell is tilted and has an effective pitch different from the structural pitch,
the method comprising a step of:
replacing an existing detection cell with the differential detection cell tilted with respect to the impulse ring.

12. The sensor-bearing according to claim 1, wherein the sensor-bearing is installed into a motorcycle axle.
